(19) United States
(12) Patent Application Publication
(10) Pub. No.: US 2022/0087252 A1
(43) Pub. Date: Mar. 24, 2022

(54) SOLUTION FOR PRESERVING AND/OR RINSING AN ORGAN TO BE TRANSPLANTED

(71) Applicant: INSTITUT GEORGES LOPEZ, Lissieu (FR)

(72) Inventors: Georges Antoine LOPEZ, Anse (FR); Alexandre LOPEZ, Tassin La Demi Lune (FR)

(21) Appl. No.: 17/538,222

(22) Filed: Nov. 30, 2021

Related U.S. Application Data
(63) Continuation-in-part of application No. 16/668,156, filed on Oct. 30, 2019, now Pat. No. 11,213,026.

(30) Foreign Application Priority Data
Sep. 27, 2019 (FR) 1910747

(51) Int. Cl. A01N 1/02

(52) U.S. Cl. CPC A01N 1/0226; A01N 1/0278

(57) ABSTRACT

Disclosed herein is a method comprising: exposing an organ to be transplanted to an aqueous solution comprising: sodium (Na⁺) ions at a concentration between 30 and 150 mmol·L⁻¹; potassium ions (K⁺) at a concentration between 10 and 40 mmol·L⁻¹; polyethylene glycol with a molecular weight of 35,000 g·mol⁻¹ (PEG 35000) at a concentration between 2 and 5 g·L⁻¹, wherein the step of exposing further comprises preserving and/or rinsing and/or reconditioning the organ in the aqueous solution.

### FIELD OF THE INVENTION

This disclosure relates to an aqueous solution for preserving and/or rinsing an organ to be transplanted and its use for static preservation, dynamic preservation (also named dynamic perfusion) and/or rinsing of an organ to be transplanted.

### STATE OF THE PRIOR ART

Organ transplantation is the last resort in the event of failure of a vital organ, which is then replaced by a healthy organ called graft.

Transplanted organs generally come from people with encephalic death (or who are brain dead), whose circulation and breathing are artificially maintained by resuscitation procedures. In France, the law states that all individuals are presumed to be donors, i. e. organ and tissue donors, unless an individual has expressed during his or her lifetime his or her refusal to have an organ removed. A waiver of organ removal may also be decided by the medical team due to the donor's medical history (tumors, infections or other diseases) or medical obstacles. In parallel, many transplants are performed from living donors, for example, kidney transplants.

After being removed from the donor, the organs are subjected to an inevitable period of blood circulation interruption or ischemia (hot and then cold) to ensure their preservation before being assigned to a compatible recipient and then transplanted.

In this context, all organs are exposed to ischemia-reperfusion syndrome lesions. This syndrome is a set of pathophysiological processes responsible for graft lesions, including alteration of cell populations.

Ischemia-reperfusion is one of the main factors leading to organ damage before transplantation, delayed and/or impaired recovery of organ function, increased risk of rejection, or reduced long-term graft survival. The result is a significant damage to organs that can no longer be transplanted or the need for a new transplant due to a relatively long-term functional failure of the graft.

Despite steady progress in the field of organ donation, the list of people waiting for an organ transplant is growing, due in particular to the success of the transplantation activity, its benefits for patients and the aging of the population. To date, more than 20,000 people are waiting for an organ transplant. In 5 years, this number has increased by 17% (Agency of Biomedicine).

The lack of organs available for transplantation is currently one of the major public health problems.

This observation leads to the search for other available grafts, or even new therapeutic possibilities. For example, xeno-transplantation (organs taken from animals) and cell therapy are possible but may not be available for several years.

Other more accessible and faster options to implement are to improve/adapt graft preservation to:
reduce the number of graft losses; and
be able to use so-called “marginal” grafts, which are generally too sensitive and deteriorate faster than “healthy” grafts, during the transplant procedure.

For example, for liver transplantation, a solution to the shortage of organs would be to use “marginal” grafts such as livers with steatosis.

Hepatic steatosis is a liver pathology associated with an excess of lipids, mainly triglycerides, within the cytoplasm of hepatocytes. The prevalence of this disease is 20% to 30% in developed countries. This is therefore a common disease whose prevalence tends to increase with the increase in cases of obesity and diabetes.

Two types of hepatic steatosis are observed, micro-vesicular steatosis with varied etiology, which is characterized by the presence of multiple small lipid vacuoles within the cytoplasm and wherein the presence thereof does not lead to displacement of the nucleus of hepatocytes. The second type of steatosis, the most severe, is macrovacuolar steatosis, wherein one of the etiologies is the excessive consumption of alcohol. This type of steatosis is characterized by a single large lipid vacuole that displaces the nucleus of hepatocytes.

Steatotic livers are more sensitive to static preservation in hypothermia. Indeed, in this pathological context, oxygen availability is reduced due to morphological abnormalities of hepatocytes.

The criteria for transplanting or not “marginal” grafts are not clear and each transplant center has its own evaluation parameters for choosing to remove and then assign a graft to a recipient.

Preservative solutions or rinsing solutions are commonly used to wash away residual blood from the graft, cool the organ or preserve it, especially during transportation.

When the organ is removed from the donor's body, it is cut off from any vascularization and subjected to a phenomenon of hot ischemia. The cells rapidly necrotize, which affects the viability of the graft. To limit this phenomenon, the organ is quickly placed in a preservation solution at +4° C. This is static hypothermic preservation, which is the most common method of preservation. The organ can be maintained in this solution until the time of transplantation.

In this context, the role of the preservation liquid is to reduce the impact of ischemia-reperfusion lesions (cellular lesions and alloimmune reaction) but also to ensure irrigation of the graft for almost complete elimination of blood, to homogeneously distribute hypothermia and to limit the harmful effects caused by cold ischemia.

However, this method ensures organ preservation for a limited period of time, for example, less than 24 hours for the kidney, 8 to 12 hours for the liver or 4 to 6 hours for the heart.

Among the main solutions used are:
Solutions for which the potassium (K⁺) concentration is higher than the sodium (Na⁺) concentration, called intracellular solutions. For example, we can mention the BELZER UW® (UW®) solution for renal, hepatic and pancreatic preservation, marketed by BRIDGE TO LIFE;
Solutions for which the potassium (K⁺) concentration is lower than the sodium (Na⁺) concentration, called extracellular solutions. For example, SAINT THOMAS® liquid for the preservation of heart grafts, marketed by LES LABORATOIRES AGUETTANT.

Document WO 00/69259 describes an extracellular preservation solution that uses as an oncotic agent a 35,000-Dalton polyethylene glycol (PEG 35) at a concentration of 0.029 mM or 1 g·L⁻¹. This preservation solution is used for static hypothermic preservation and has shown properties in endothelial cell protection as well as antioxidant properties for renal and hepatic preservation before transplantation.

A first possibility for the preservation and transport of graft is to immerse the organ to be transplanted in the preservation solution maintained at between +2 and +8° C. (static hypothermic preservation) as mentioned above. There is no circulation of the solution in the graft.

An alternative is to continuously infuse the graft until it is implanted in the recipient (dynamic preservation) in hypothermic conditions.

The principle of dynamic preservation requires the use of a perfusion machine (or IM) and is based on a continuous or pulsatile controlled circulation of a perfusion (or solution).

To date, there are two types of IM: continuous flow or pulsatile flow machines. This flow provides a supplement of nutrients with more or less oxygen while the toxic waste and free radicals produced can be eliminated.

For example, the Lifeport® machine, marketed by ORGAN RECOVERY SYSTEM, is a machine used for the hypothermic perfusion of renal grafts. One of the solutions used with this machine is the Belzer-MPS® solution, derived from the UW® solution.

The RM3® machine is a pulsatile IM marketed by IGL and which allows the transport of one or two kidneys. It has a regulated pumping system that mimics the systole and diastole phenomena observed in the heart.

The preservation solution used in a perfusion machine must be chosen carefully, particularly with regard to its viscosity, to ensure an efficient and continuous perfusion of the graft.

Dynamic preservation has some advantages compared to static preservation.

One of them is that dynamic preservation improves the conditions of the organ compared to static preservation for the same duration of preservation.

Another advantage is that the dynamic preservation may be conducted for a duration longer than for static preservation, which gives more time to the physician between 2 transplantations.

Another advantage is that the longer duration of dynamic preservation makes this method of interest for organ reconditioning.

Organ reconditioning method takes place between the end of the cold storage of the organ and immediately before its transplantation.

Furthermore, it is necessary to clean the organ with a rinsing liquid, for example, of the type described in the application WO 2012/150392. This document describes an extracellular rinsing solution containing a high proportion of PEG and an amount of K⁺ less than 10 mmol·L⁻¹. The organ is then preserved by choosing another solution that corresponds to a preservation solution adapted to the selected preservation system (static or dynamic) and possibly reconditioned by selecting the same or another dynamic preservation solution. In addition, it appears from the above developed features that the preservation solution must also be chosen based on the organ to be transplanted.

In other words, there is no suitable solution, particularly in terms of formulation and viscosity, that can be used to rinse the graft but also to preserve the graft, whether in a static or dynamic system and optionally to recondition the graft before transplantation.

There is, therefore, an evident need to develop a universal solution that can ensure the rinsing of a graft and at the same time its effective preservation through the implementation of static or dynamic preservation methods and optionally its reconditioning. In addition, this solution should be able to rinse and/or preserve “marginal” grafts.

### BRIEF DESCRIPTION OF DRAWINGS

FIG. 1 represents the quantification of aldehyde dehydrogenase-2 (ALDH 2) activity after 24 hours of static hypothermic preservation of a liver in a UW®, IGL-0, IGL-1 solution or solution according to one aspect of the present disclosure (INV).

FIG. 2 represents the quantification of transaminase content in liver tissue after 24 hours of static hypothermic preservation of a liver in UW®, IGL-1 solution or solution according to one aspect of the present disclosure (INV).

FIG. 3 represents the quantification of the glutamate dehydrogenase (GLDH) content in liver tissue after 24 hours of static hypothermic preservation of a liver in UW®, IGL-1 solution or solution according to one aspect of the present disclosure (INV).

FIG. 4 represents the determination of the amount of cells present in the rinse effluent of a healthy liver or a steatotic liver, rinsed with IGL-1® solution or solution according to one aspect of the present disclosure (INV).

FIG. 5 represents the quantification of the number of red blood cells remaining in the liver tissue after rinsing a healthy liver or a steatotic liver with UW®, IGL-1® solution or solution according to one aspect of the present disclosure (INV).

FIG. 6 represents the evaluation of aldehyde dehydrogenase-2 (ALDH 2) activity in the liver after dynamic hypothermic preservation with PERF-GEN® solution or solution according to one aspect of the present disclosure (INV).

FIG. 7 represents the evaluation of hepatic parenchyma degradation by measuring the aspartate aminotransferase (ASAT) content in the liver after dynamic hypothermic preservation with PERF-GEN® solution or solution according to one aspect of the present disclosure (INV).

FIG. 8 represents the evaluation of hepatic parenchyma degradation by measuring the glutamate dehydrogenase (GLDH) content in the liver after dynamic hypothermic preservation with PERF-GEN® solution or solution according to one aspect of the present disclosure (INV).

FIG. 9 represents the evaluation of heart cells degradation by measuring the aspartate aminotransferase (ASAT) content in the heart after static hypothermic preservation with Celsior® solution or solution according to one aspect of the present disclosure (INV). More specifically, FIG. 9 shows ASAT concentration after 2 h and 4 h of static hypothermic preservation.

FIG. 10 represents the evaluation of heart cells degradation by measuring the aspartate aminotransferase (ASAT) content in the heart after dynamic hypothermic preservation with Celsior® solution or solution according to one aspect of the present disclosure (INV). More specifically, FIG. 10 shows ASAT concentration after 2h and 4 h of dynamic hypothermic preservation.

### DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary embodiments of articles, systems, and/or methods disclosed unless otherwise specified, as such can, of course, vary. It is also to be understood that the terminology used herein is for the purpose of describing particular embodiments only and is not intended to be limiting.

The following description of the invention is provided as an enabling teaching of the invention in its best, currently known embodiment. To this end, those skilled in the relevant art will recognize and appreciate that many changes can be made to the various embodiments of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof

Definitions

As used in this application and in the claims, the singular forms “a,” “an,” and “the” include the plural forms unless the context clearly dictates otherwise. Thus, for example, reference to a “salt” includes embodiments having two or more such salts unless the context clearly indicates otherwise.

It is also to be understood that the terminology used herein is for the purpose of describing particular embodiments only and is not intended to be limiting. As used in the specification and in the claims, the term “comprising” can include the embodiments “consisting of” and “consisting essentially of” Additionally, the term “includes” means “comprises.”

For the terms “for example,” “exemplary,” and “such as,” and grammatical equivalences thereof, the phrase “and without limitation” is understood to follow unless explicitly stated otherwise.

As used herein, the terms “optional” or “optionally” mean that the subsequently described event or circumstance may or may not occur and that the description includes instances where said event or circumstance occurs and instances where it does not.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

The Applicant has developed a new generation of solution for the preservation and/or rinsing of organs to be transplanted that solves the problems of the prior art mentioned above.

In a particular aspect, the solution according to this disclosure ensures a better rinsing and/or preservation of the graft, allowing to reduce cellular alterations as well as damage to the organ's function. In certain aspects, the solution according to this disclosure is also effective for rinsing and/or preserving “marginal” grafts.

The result is an increase in the number of transplant candidates, a faster and more efficient functional recovery of the graft and an improvement in the quality of the organs to be transplanted.

Contrary to all expectations, the presence of PEG 35 at a concentration greater than 1 g·L⁻¹ in a solution with a specific composition of sodium ions (Na⁺) and (K⁺) does not alter its initial viscosity and makes it a solution suitable for static preservation as well as for perfusion machines (IM).

According to a first aspect, this disclosure relates to an aqueous solution for preserving and/or rinsing transplanted organs comprising:
sodium (Na⁺) ions at a concentration between 30 and 150 mmol·L⁻¹;
potassium ions (K⁺) at a concentration between 10 and 40 mmol·L⁻¹;
polyethylene glycol with a molecular weight of 35,000 g·mol⁻¹ (PEG 35000) at a mass concentration between 2 and 5 g·L⁻¹.

In still further aspects, the sodium ions can be present at a concentration between 30 and 150 mmol·L⁻¹, including exemplary values of 40 mmol·L⁻¹, 50 mmol·L⁻¹, 60 mmol·L⁻¹, 70 mmol·L⁻¹, 80 mmol·L⁻¹, 90 mmol·L⁻¹, 100 mmol·L⁻¹, 110 mmol·L⁻¹, 120 mmol·L⁻¹, 130 mmol·L⁻¹, and 140 mmol·L⁻¹.

In yet other aspects, the potassium ions can be present at a concentration between 10 and 40 mmol·L⁻¹, including exemplary values of 15 mmol·L⁻¹, 20 mmol·L⁻¹, 25 mmol·L⁻¹, 30 mmol·L⁻¹, and 35 mmol·L⁻¹.

In yet other aspects, the polyethylene glycol with a molecular weight of 35,000 g·mol⁻¹ (PEG 35000) is present at a mass concentration between 2 and 5 g·L⁻¹, including exemplary values of 2.2 g·L⁻¹, 2.5 g·L⁻¹, 2.7 g·L⁻¹, 3.0 g·L⁻¹, 3.2 g·L⁻¹, 3.5 g·L⁻¹, 3.7 g·L⁻¹, 4.0 g·L⁻¹, 4.2 g·L⁻¹, 4.5 g·L⁻¹, and 4.7 g·L⁻¹.

Therefore, according to some aspects of this disclosure, polyethylene glycol has a molar concentration between 0.057 and 0.143 mmol·L⁻¹, including exemplary values of 0.06 mmol·L⁻¹, 0.065 mmol·L⁻¹, 0.07 mmol·L⁻¹, 0.075 mmol·L⁻¹, 0.08 mmol·L⁻¹, 0.085 mmol·L⁻¹, 0.09 mmol·L⁻¹, 0.1 mmol·L⁻¹, 0.105 mmol·L⁻¹, 0.110 mmol·L⁻¹, 0.115 mmol·L⁻¹, 0.120 mmol·L⁻¹, 0.125 mmol·L⁻¹, 0.130 mmol·L⁻¹, 0.135 mmol·L⁻¹, and 0.140 mmol·L⁻¹.

According to this disclosure, “solution” refers to a homogeneous mixture, comprising a single phase (solvent), containing at least one substance (solute) dissolved in the solvent.

According to this disclosure, “preservation” refers to the ex vivo maintenance of the viability of the cells of the organ to be transplanted as well as its physiological functions. According to this disclosure, the term “conservation” may be used to refer to the same mechanism.

According to this disclosure, “rinsing” refers to the action of cleaning the organ to be transplanted after its collection to remove residual blood, eliminate degradation products of cellular metabolism or catabolites (e. g. endothelin) released after hot ischemia or eliminate the accumulation of large amounts of potassium likely to cause heart rhythm disorders in the recipient.

According to this disclosure, the terms “organ to be transplanted” or “graft” refer to the same object, namely, an organ or tissue to be transplanted from a donor to a recipient by surgical intervention in order to replace a failed organ.

According to this disclosure, “transplantation” refers to the transfer of a whole organ from a donor, involving the restoration of the related and efferent vascular continuity of this organ with the recipient's circulatory system. In a broader sense, the term “graft” can be used.

According to a particular embodiment, the solution is of the extracellular type in that it contains a higher concentration of Na⁺ than K⁺

According to a particular embodiment, the aqueous solution according to this disclosure also includes glutathione, as an antioxidant agent, at a concentration advantageously between 1 and 11 mmol·L⁻¹, including exemplary values of 2 mmol·L⁻¹, 3 mmol·L⁻¹, 4 mmol·L⁻¹, 5 mmol·L⁻¹, 6 mmol·L⁻¹, 7 mmol·L⁻¹, 8 mmol·L⁻¹, 9 mmol·L⁻¹, and 10 mmol·L⁻¹.

It is understood that glutathione is an enzyme that engages, in certain aspects, in the elimination of free radicals (or reactive oxygen species, ROS) to reduce the phenomenon of oxidative stress that causes deterioration of the organ to be transplanted.

According to a preferred embodiment, the solution according to this disclosure can also comprise zinc ions (Zn²⁺) at a concentration advantageously between 0.08 and 0.210 mmol·L⁻¹, including exemplary values of 0.09 mmol·L⁻¹, 0.10 mmol·L⁻¹, 0.120 mmol·L⁻¹, 0.150 mmol·L⁻¹, 0.170 mmol·L⁻¹, and 0.200 mmol·L⁻¹. In yet other aspects, zinc ions can be present preferably at a concentration between 0.08 and 0.170 mmol·L−1, or even more preferably between 0.08 and 0. 10 mmol·L⁻¹, including exemplary values of 0.081 mmol·L⁻¹, 0.082 mmol·L⁻¹, 0.083 mmol·L⁻¹, 0.084 mmol·L⁻¹, 0.085 mmol·L⁻¹, 0.086 mmol·L⁻¹, 0.087 mmol·L^{—1}, 0.088 mmol·L^{—1}, 0.089 mmol·L⁻¹, 0.090 mmol·L⁻¹, 0.091 mmol·L⁻¹, 0.092 mmol·L⁻¹, 0.093 mmol·L⁻¹, 0.094 mmol·L⁻¹, 0.095 mmol·L⁻¹, 0.096 mmol·L⁻¹, 0.097 mmol·L⁻¹, 0.098 mmol·L^{—1}, and 0.099 mmol·L⁻¹.

According to another particular embodiment, the solution according to this disclosure also includes zinc ions (Zn²⁺) at a concentration advantageously between 0.170 and 0.210 mmol·L⁻¹, including exemplary values of 0.175 mmol·L⁻¹, 0.180 mmol·L⁻¹, 0.185 mmol·L⁻¹, 0.190 mmol·L⁻¹, 0.195 mmol·L⁻¹, 0.200 mmol·L⁻¹, and 0.205 mmol·L⁻¹. In yet other aspects, zinc ions can be present, for example, at a concentration of 0.191 mmol·L⁻¹.

Zinc plays several roles in cellular metabolism, including being a cofactor in activating the endothelial form of nitric oxide synthase (or eNOS or NOS3). Zinc, therefore, indirectly contributes to the increase in nitric oxide concentration in the graft.

Advantageously, Zn²⁺ ions are provided by a zinc salt, for example, zinc gluconate or zinc chloride, preferably zinc chloride.

According to a particular embodiment, the solution according to this disclosure also includes nitrite ions (NO²⁻) at a concentration advantageously between 5 and 100 nmol·L⁻¹, including exemplary values of 10 nmol·L⁻¹, 20 nmol·L⁻¹, 30 nmol·L⁻¹, 40 nmol·L⁻¹, 50 nmol·L⁻¹, 60 nmol·L^{—1}, 70 nmol·L⁻¹, 80 nmol·L⁻¹, and 90 nmol·L⁻¹.

Nitrite is the soluble form of nitrous monoxide or nitric oxide (NO), which induces vasodilation of the endothelium of blood vessels, causing an increase in blood flow.

Advantageously, NO²⁻ ions are provided by a nitrite salt, for example, sodium nitrite (NaNO₂), calcium nitrite (Ca(NO₂)₂ or potassium nitrite (KNO₂), preferably sodium nitrite (NaNO₂).

According to a particular embodiment, the pH of the preservation and/or rinsing solution according to this disclosure is advantageously between 7.2 and 7.6, including exemplary values of 7.3, 7.4, and 7.5.

According to a particular embodiment, the osmolarity of the solution is advantageously between 250 and 380 mosm·L⁻¹, including exemplary values of 260 mosm·L⁻¹, 270 mosm·L⁻¹, 280 mosm·L⁻¹, 290 mosm·L⁻¹, 300 mosm·L⁻¹, 310 mosm·L⁻¹, 320 mosm·L⁻¹, 330 mosm·L⁻¹, 340 mosm·L⁻¹, 350 mosm·L⁻¹, 360 mosm·L⁻¹, and 370 mosm·L⁻¹.

According to a particular embodiment, the solution according to this disclosure further comprises at least one impermeant anion, at least one sugar, at least one cell membrane stabilizing agent, a buffer solution and/or at least one energy source.

According to a particular embodiment, the solution according to this disclosure also comprises:
raffmose at a concentration advantageously between 25 and 35 mmol·L⁻¹, including exemplary values of 26 mmol·L⁻¹, 27 mmol·L⁻¹, 28 mmol·L⁻¹, 29 mmol·L⁻¹, 30 mmol·L⁻¹, 31 mmol·L⁻¹, 32 mmol·L⁻¹, 33 mmol·L⁻¹, and 34 mmol·L⁻¹ ; and allopurinol at a concentration advantageously between 0.5 and 1.5 mmol·L⁻¹, including exemplary values of 0.6 mmol·L⁻¹, 0.7 mmol·L⁻¹, 0.8 mmol·L⁻¹, 0.9 mmol·L⁻¹, 1.0 mmol·L⁻¹, 1.1 mmol·L⁻¹, 1.2 mmol·L⁻¹, 1.3 mmol·L⁻¹, and 1.4 mmol·L⁻¹; or alternatively
mannitol at a concentration advantageously between 40 and 80 mmol·L⁻¹, including exemplary values of 45 mmol·L⁻¹, 50 mmol·L⁻¹, 55 mmol·L⁻¹, 60 mmol·L⁻¹, 65 mmol·L⁻¹, 70 mmol·L⁻¹, and 75 mmol·L⁻¹.

According to a particular embodiment, the solution according to this disclosure also comprises:
raffmose at a concentration advantageously between 25 and 35 mmol·L⁻¹, including exemplary values of 26 mmol·L⁻¹, 27 mmol·L⁻¹, 28 mmol·L⁻¹, 29 mmol·L⁻¹, 30 mmol·L⁻¹, 31 mmol·L⁻¹, 32 mmol·L⁻¹, 33 mmol·L⁻¹, and 34 mmol·L⁻¹; and allopurinol at a concentration advantageously between 0.5 and 1.5 mmol·L⁻¹, including exemplary values of 0.6 mmol·L⁻¹, 0.7 mmol·L⁻¹, 0.8 mmol·L⁻¹, 0.9 mmol·L⁻¹, 1.0 mmol·L⁻¹, 1.1 mmol·L⁻¹, 1.2 mmol·L⁻¹, 1.3 mmol·L⁻¹, and 1.4 mmol·L⁻¹; or alternatively
mannitol at a concentration advantageously between 40 and 80 mmol·L⁻¹, including exemplary values of 45 mmol·L⁻¹, 50 mmol·L⁻¹, 55 mmol·L⁻¹, 60 mmol·L⁻¹, 65 mmol·L⁻¹, 70 mmol·L⁻¹, and 75 mmol·L⁻¹, and histidine at a concentration advantageously between 25 and 35 mmol·L⁻¹, including exemplary values of 26 mmol·L⁻¹, 27 mmol·L⁻¹, 28 mmol·L⁻¹, 29 mmol·L⁻¹, 30 mmol·L⁻¹, 31 mmol·L⁻¹, 32 mmol·L⁻¹, 33 mmol·L⁻¹, and 34 mmol·L⁻¹.

In a particular embodiment, the solution according to this disclosure also includes:
lactobionic acid at a concentration advantageously between 80 and 120 mmol·L⁻¹, including exemplary values of 85 mmol·L⁻¹, 90 mmol·L⁻¹, 95 mmol·L⁻¹, 100 mmol·L⁻¹, 105 mmol·L⁻¹, 110 mmol·L⁻¹, and 115 mmol·L⁻¹;
sulphate ions (SO₄²⁻), preferably provided by magnesium sulphate (MgSO₄), at a concentration advantageously between 4 and 6 mmol·L⁻¹, including exemplary values of 4.1 mmol·L⁻¹, 4.2 mmol·L⁻¹, 4.3 mmol·L⁻¹, 4.4 mmol·L⁻¹, 4.5 mmol·L⁻¹, 4.6 mmol·L⁻¹, 4.7 mmol·L⁻¹, 4.8 mmol·L⁻¹, 4.9 mmol·L⁻¹, 5.0 mmol·L⁻¹, 5.1 mmol·L⁻¹, 5.2 mmol·L⁻¹, 5.3 mmol·L⁻¹, 5.4 mmol·L⁻¹, 5.5 mmol·L⁻¹, 5.6 mmol·L⁻¹, 5.7 mmol·L⁻¹, 5.3 mmol·L⁻¹, and 5.9 mmol·L⁻¹;
phosphate ions (PO₄³⁻), preferably provided by potassium phosphate (KH₂PO₄), at a concentration advantageously between 20 and 30 mmol·L⁻¹, including exemplary values of 21 mmol·L⁻¹, 22 mmol·L⁻¹, 23 mmol·L⁻¹, 24 mmol·L⁻¹, 25 mmol·L⁻¹, 26 mmol·L⁻¹, 27 mmol·L⁻¹, 28 mmol·L⁻¹, and 29 mmol·L⁻¹; and
adenosine at a concentration advantageously between 4 and 6 mmol·L⁻¹, including exemplary values of 4.1 mmol·L⁻¹, 4.2 mmol·L⁻¹, 4.3 mmol·L⁻¹, 4.4 mmol·L⁻¹, 4.5 mmol·L⁻¹, 4.6 mmol·L⁻¹, 4.7 mmol·L⁻¹, 4.8 mmol·L⁻¹, 4.9 mmol·L⁻¹, 5.0 mmol·L⁻¹, 5.1 mmol·L⁻¹, 5.2 mmol·L⁻¹, 5.3 mmol·L⁻¹, 5.4 mmol·L⁻¹, 5.5 mmol·L⁻¹, 5.6 mmol·L⁻¹, 5.7 mmol·L⁻¹, 5.3 mmol·L⁻¹, and 5.9 mmol·L⁻¹.

In a preferred embodiment, the composition of the solution according to this disclosure includes:
PEG 35000 at a concentration of 5 g·L⁻¹;
glutathione at a concentration of 9 mmol·L⁻¹;
Zn²⁺ ions at a concentration of 0.191 mmol·L⁻¹;
NO²⁻ ions at a concentration of 50 nmol·L⁻¹;
raffinose at a concentration of 30 mmol·L⁻¹;
lactobionic acid at a concentration of 100 mmol·L⁻¹;
SO₄²⁻ ions, preferably provided by MgSO₄, at a concentration of 5 mmol·L⁻¹;
PO₄³⁻ ions, preferably provided by KH₂PO₄, at a concentration of 25 mmol·L⁻¹;
adenosine at a concentration of 5 mmol·L⁻¹;
allopurinol at a concentration of 1 mmol·L⁻¹.

In another preferred embodiment, the composition of the solution according to this disclosure includes:
PEG 35000 at a concentration of 5 g·L⁻¹;
glutathione at a concentration of 9 mmol·L⁻¹;
Zn²⁺ ions at a concentration of 0.091 mmol·L⁻¹;
NO²⁻ ions at a concentration of 50 nmol·L⁻¹;
raffinose at a concentration of 30 mmol·L⁻¹;
lactobionic acid at a concentration of 100 mmol·L⁻¹;
SO₄²⁻ ions, preferably provided by MgSO₄, at a concentration of 5 mmol·L⁻¹;
PO₄³⁻ ions, preferably provided by KH₂PO₄, at a concentration of 25 mmol·L⁻¹;
adenosine at a concentration of 5 mmol·L⁻¹,
allopurinol at a concentration of 1 mmol·L⁻¹.

In another preferred embodiment, the composition of the solution according to this disclosure includes:
PEG 35000 at a concentration of 5 g·L⁻¹;
glutathione at a concentration of 9 mmol·L⁻¹;
Zn²⁺ ions at a concentration of 0.191 mmol·L⁻¹;
NO²⁻ ions at a concentration of 50 nmol·L⁻¹;
mannitol at a concentration of 60 mmol·L⁻¹;
lactobionic acid at a concentration of 100 mmol·L⁻¹;
SO₄²⁻ ions, preferably provided by MgSO₄, at a concentration of 5 mmol·L⁻¹;
PO₄³⁻ ions, preferably provided by KH₂PO₄, at a concentration of 25 mmol·L⁻¹;
adenosine at a concentration of 5 mmol·L⁻¹.

In another preferred embodiment, the composition of the solution according to this disclosure includes:
PEG 35000 at a concentration of 5 g·L⁻¹;
glutathione at a concentration of 9 mmol·L⁻¹;
Zn²⁺ ions at a concentration of 0.091 mmol·L⁻¹;
NO²⁻ ions at a concentration of 50 nmol·L⁻¹;
mannitol at a concentration of 60 mmol·L⁻¹;
lactobionic acid at a concentration of 100 mmol·L⁻¹;
SO₄²⁻ ions, preferably provided by MgSO₄, at a concentration of 5 mmol·L⁻¹;
PO₄³⁻ ions, preferably provided by KH₂PO₄, at a concentration of 25 mmol·L⁻¹;
adenosine at a concentration of 5 mmol·L⁻¹.

In another preferred embodiment, the composition of the solution according to this disclosure includes:
PEG 35000 at a concentration of 5 g·L⁻¹;
glutathione at a concentration of 9 mmol·L⁻¹;
Zn²⁺ ions at a concentration of 0.191 mmol·L⁻¹;
NO²⁻ ions at a concentration of 50 nmol·L⁻¹;
mannitol at a concentration of 60 mmol·L⁻¹;
histidine at a concentration of 30 mmol·L⁻¹;
lactobionic acid at a concentration of 100 mmol·L⁻¹;
SO₄²⁻ ions, preferably provided by MgSO₄, at a concentration of 5 mmol·L⁻¹;
PO₄³⁻ ions, preferably provided by KH₂PO₄, at a concentration of 25 mmol·L⁻¹;
adenosine at a concentration of 5 mmol·L⁻¹.

In another preferred embodiment, the composition of the solution according to this disclosure includes:
PEG 35000 at a concentration of 5 g·L⁻¹;
glutathione at a concentration of 9 mmol·L⁻¹;
Zn²⁺ ions at a concentration of 0.091 mmol·L⁻¹;
NO²⁻ ions at a concentration of 50 nmol·L⁻¹;
mannitol at a concentration of 60 mmol·L⁻¹;
histidine at a concentration of 30 mmol·L⁻¹;
lactobionic acid at a concentration of 100 mmol·L⁻¹;
SO₄²⁻ ions, preferably provided by MgSO₄, at a concentration of 5 mmol·L⁻¹;
PO₄³⁻ ions, preferably provided by KH₂PO₄, at a concentration of 25 mmol·L⁻¹;
adenosine at a concentration of 5 mmol·L⁻¹.

In another aspect, the disclosure concerns a method comprising:
exposing an organ to be transplanted to an aqueous solution comprising:
   sodium (Na+) ions at a concentration between 30 and 150 mmol·L−1;
   potassium ions (K+) at a concentration between 10 and 40 mmol·L−1;
   polyethylene glycol with a molecular weight of 35,000 g·mol−1 (PEG 35000) at a concentration between 2 and 5 g·L−1; and

wherein the step of exposing further comprises preserving and/or rinsing the organ in the aqueous solution.

In still further aspects, the sodium ions can be present at a concentration between 30 and 150 mmol·L⁻¹, including exemplary values of 40 mmol·L⁻¹, 50 mmol·L⁻¹, 60 mmol·L⁻¹, 70 mmol·L⁻¹, 80 mmol·L⁻¹, 90 mmol·L⁻¹, 100 mmol·L⁻¹, 110 mmol·L⁻¹, 120 mmol·L⁻¹, 130 mmol·L⁻¹, and 140 mmol·L⁻¹.

In yet other aspects, the potassium ions can be present at a concentration between 10 and 40 mmol·L⁻¹, including exemplary values of 15 mmol·L⁻¹, 20 mmol·L⁻¹, 25 mmol·L⁻¹, 30 mmol·L⁻¹, and 35 mmol·L⁻¹.

In yet other aspects, the polyethylene glycol with a molecular weight of 35,000 g·mol⁻¹ (PEG 35000) is present at a mass concentration between 2 and 5 g·L⁻¹, including exemplary values of 2.2 g·L⁻¹, 2.5 g·L⁻¹, 2.7 g·L⁻¹, 3.0 g·L⁻¹, 3.2 g·L⁻¹, 3.5 g·L⁻¹, 3.7 g·L⁻¹, 4.0 g·L⁻¹, 4.2 g·L⁻¹, 4.5 g·L⁻¹, and 4.7 g·L⁻¹.

According to a specific embodiment, the step of preserving is static.

According to the method of the disclosure, the step of static preservation involves the aqueous solution having a temperature advantageously between +1 and +12° C., including exemplary values of +2, +3, +4, +5, +6, +7, +8, +9, +10 and +11° C. In yet other aspects, the solution can have a temperature preferably between +2 and +8° C., for example, +5° C.

According to a specific embodiment, the step of preserving is dynamic

According to the method of disclosure, the step of dynamic preservation involves the aqueous solution having a temperature advantageously between +1 and +12° C., including exemplary values of +2, +3, +4, +5, +6, +7, +8, +9, +10 and +11° C. In yet other aspects, the solution can have a temperature preferably 5 between +2 and +8° C., for example, +5° C.

According to a first embodiment, when the method involves a dynamic perfusion, the method further involves the step of perfusing the organ continuously, especially perfusion into a continuous flow machine.

According to a second embodiment, when the method involves a dynamic perfusion, the method further involves the step of perfusing the organ with a pulsatile flow, especially perfusion in a pulsatile flow machine.

According to the disclosure, the step of rinsing involves the aqueous solution having a temperature advantageously between +1 and +12° C., including exemplary values of +2, +3, +4, +5, +6, +7, +8, +9, +10 and +11° C. In yet other aspects, the solution can have a temperature preferably between +2 and +8° C., for example, +5° C.

According to a particular embodiment, the solution according to this disclosure is used to rinse the organ to be transplanted and to ensure its preservation, static or dynamic, before transplantation to a patient.

According to another embodiment, the step of exposing an organ to the solution disclosed herein further comprises preserving and/or rinsing and/or reconditioning the organ for transplantation.

Practically, the step of reconditioning involves any of the disclosed herein solutions having a temperature advantageously between +1 and +12° C., including exemplary values of +2, +3, +4, +5, +6, +7, +8, +9 , +10 and +11° C. In yet other aspects, the solution can have a temperature preferably between +2 and +8° C., for example, +5° C.

According to a particular embodiment, the organ to be transplanted is a healthy or “marginal” organ.

According to a particular embodiment, the organ to be transplanted is an abdominal organ, preferably the liver, pancreas, kidney or intestines.

According to another embodiment, the organ is the heart or the lung.

According to a particular embodiment, the liver to be transplanted is a healthy liver or a steatotic liver.

According to another embodiment, the organ to be transplanted is a tissue.

For example, a tissue according to this disclosure is the cornea, bone, skin, blood vessels, tendons or heart valves.

The invention and the advantages deriving therefrom will be better understood from the following figures and examples provided as a non-limiting illustration of the invention.

### EXAMPLE EMBODIMENT OF THE INVENTION

1. Preparation of the Preservation and Rinsing Solution According to this Disclosure

A solution according to this disclosure is prepared by mixing the ingredients according to the formulation (per 1 liter) in Table 1:

TABLE 1

| Ingredient | Concentration |
|---|---|
| PEG 35000 (molecular | 0.14 mM |
| weight 35,000 g.L⁻¹) | (5 g.L⁻¹) |
| Na⁺ (provided by NaOH) | 125 mM |
| K⁺ (provided by KH₂PO₄) | 25 mM |
| Zn²⁺ (provided by ZnCl₂) | 0.191 mM |
| Glutathion | 9 mM |
| NO²⁻ (provided by NaNO₂) | 50 nM |
| Raffinose | 30 mM |
| Lactobionic acid | 100 mM |
| SO₄²⁻ (provided by MgSO₄) | 5 mM |
| PO₄³⁻ (provided by KH₂PO₄) | 25 mM |
| Adenosine | 5 mM |
| Allopurinol | 1 mM |

The preparation of the solution consists in dissolving all the ingredients, under magnetic agitation, in an aqueous solution, and the pH of the obtained solution is adjusted to 7.4.

2. Comparison of the Viscosity of the Solutions of the Prior Art Compared to the Solution According to this Disclosure

The viscosity was determined by the European Pharmacopoeia method in Chapter 2.2.9 “Viscosity—Capillary tube method.”

TABLE 2

| Solution 1 | IGL-1 ® | INV | Perf-Gen ® |
|---|---|---|---|
| Use | Static | Rinsing + Static | Dynamic |
| | preservation | preservation + | preservation |
| | | dynamic | |
| | | preservation | |
| Oncotic agent | PEG 35 | PEG 35 | HES |
| | (1 g.L⁻¹) | (5 g.L⁻¹) | (50 g.L⁻¹) |
| Viscosity (cP) | 1.2 | 1.4 | 2.4 |

These results show that, unexpectedly, the significant increase in the PEG concentration in the INV solution compared to the IGL-1® solution does not induce an increase in the viscosity of the solution.

The viscosity of the solution according to this disclosure is therefore adapted to its use for static (such as IGL-1®) and dynamic (such as Perf-Gen®) preservation.

3. Static Preservation of a Liver Under Hypothermia Condition

To assess the effectiveness of the preservation solution according to this disclosure, evaluations were carried out on healthy livers or livers suffering from steatosis.

3.1. Experimental Conditions

The liver of normal (healthy) and obese rats (Zucker rats; steatotic liver and referred to as “Ob” or “fatty” in the figures) aged 10 to 12 weeks was collected and stored according to techniques known to the skilled person.

The purpose of these experiments is to compare the performance of the solution according to this disclosure (INV Solution) on the preservation of the liver in hypothermia ex vivo compared to an IGL-0 solution (IGL-1® solution formulated without PEG) or to prior art solutions, namely:
Belzer UW® solution (hereinafter referred to as UW);
IGL-1® solution.

The organ is then stored statically in the rinsing solution (100 mL; HTK®, IGL-1® or INV) for 24 hours at 4° C.

Different parameters were measured to evaluate the effectiveness of the solution according to this disclosure on liver preservation in hypothermia conditions.

3.2. Quantification of Aldehyde Dehydrogenase-2 Content in Liver Tissue

Mitochondrial aldehyde dehydrogenase 2 (ALDH 2) is a major enzyme in aldehyde metabolism that protects against toxic accumulation of aldehyde at the cellular level, for example, by converting acetaldehyde to acetic acid. The activation of aldehyde dehydrogenase-2 (ALDH2) is associated with protection of the cells of the organ to be transplanted.

After 24 hours of preservation in UW®, IGL-0 (IGL-1® solution formulated without PEG), IGL-1® or INV solutions, an analysis of ALDH2 activation by enzyme kit was performed on healthy livers.

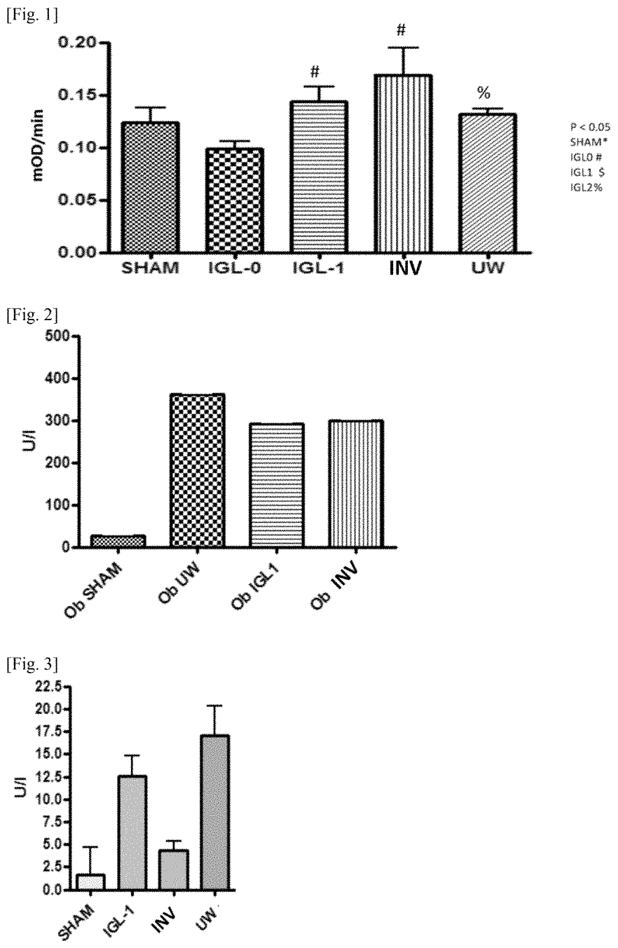

The results are shown in FIG. 1.

The data show that preserving the liver in an INV solution induces an increase in ALDH2 activity in tissue compared to IGL-0, IGL-1® and UW® solutions. The result is protection of the organ against damage caused by ischemia.

The formulation of IGL-0 and UW solutions is PEG-free. These results, therefore, show that the PEG 35 used at a concentration according to this disclosure in the INV solution provides better organ protection (value of p<0.05).

3.3. Quantification of Transaminase Content in Liver Tissue

Transaminases (alanine aminotransferase, aspartate aminotransferase and the like) are enzymes synthesized by hepatocytes and released in case of hepatocellular lesion or necrosis. The transaminase concentration is therefore a marker of the effectiveness of liver preservation with a preservation solution.

After 24 hours of preservation in UW®, IGL-1® or INV solutions, a quantitative analysis of transaminase levels by enzyme kit was performed on steatotic livers.

The results are shown in FIG. 2.

The data show that the transaminase concentration is lower after 24 hours of preservation with the INV solution according to this disclosure than with the UW® solution. In other words, the INV solution provides better preservation than the UW® solution.

3.4. Quantification of Glutamate Dehydrogenase Content in Liver Tissue

Glutamate dehydrogenase (GLDH) is a liver-specific mitochondrial enzyme that plays an important role in amino acid catabolism. It participates in the deamination of glutamic acid (or glutamate) to a-ketoglutarate acid. An increase in serum GLDH concentration indicates a degradation of the hepatic parenchyma and more specifically a degradation of the mitochondria.

After 24 hours of preservation in UW®, IGL-1® or INV solutions, a quantitative analysis of GLDH levels by enzyme kit was performed on steatotic livers.

The results are shown in FIG. 3.

The data show that the GLDH concentration is 2.5 times lower after 24 hours of preservation with the INV solution compared to the IGL-1® solution and 5 times lower than with the UW® solution. These results indicate that the INV solution provides better preservation of the liver to be transplanted than solutions of the prior art.

4. Rinsing a Liver to be Transplanted

4.1. Experimental Conditions

The liver of normal (healthy) and obese rats (Zucker rats; steatotic liver and referred to as “Ob” or “fatty” in the figures) aged 10 to 12 weeks was collected then washed using techniques known to the skilled person.

The purpose of these experiments is to compare the rinsing performance of the solution according to this disclosure (INV Solution) against the solutions of the prior art, namely:
Belzer UW® solution (hereinafter referred to as UW);
HTK® Preservative Solution (for histidine-tryptophan-ketoglutarate or Custodiol® HTK solution);
IGL-1® solution.

The liver is rinsed by influx of the rinsing solution through the aorta and efflux through the portal vein.

Different parameters were measured to evaluate the effectiveness of the solution according to this disclosure on hepatic rinsing.

4.2. Determination of the Amount of Cells Present in the Liver Tissue Rinse Effluent

The rinsing performance of the solution according to this disclosure (INV) is evaluated at:
T0 (aortic dissection after the total flushing volume has passed through the aorta in all experimental groups except HTK);
T1 (after the total rinse volume has passed through the aorta in the HTK group);
T2 (after the total rinse volume has passed through the portal vein); and
T24 (24 hours post-ischemia), on healthy and steatotic livers, compared to IGL-1® solution.

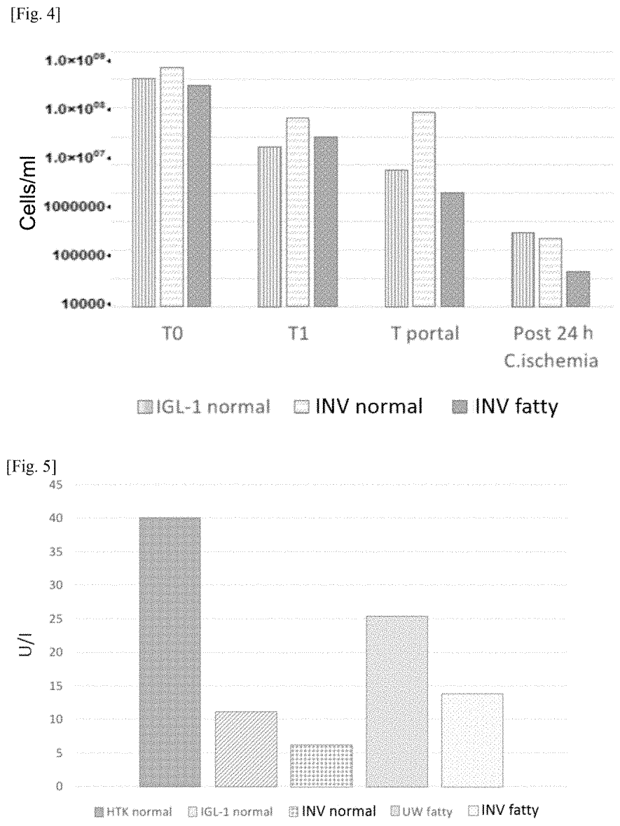

The results are shown in FIG. 4.

The data show that, for the healthy liver, the effluent obtained after rinsing the liver with INV solution is more concentrated in cells, in this case in red blood cells, than IGL-1® solution at T0, T1 and T2. The INV effluent is therefore “dirtier,” more concentrated in red blood cells, than IGL-1 effluent throughout the liver harvesting procedure. The INV solution according to this disclosure, therefore, ensures a better liver flushing than the IGL-1® solution.

As known to the skilled person, the rinsing of a steatotic liver is less effective than that of a healthy liver due to cellular and tissue damage. The results show that the INV solution induces a decrease in cell concentration in the effluent over time. These data therefore reflect that the solution according to this disclosure ensures an effective rinsing of the steatotic liver.

4.3. Quantification of the Number of Red Blood Cells Present in the Liver Tissue after Rinsing

A histological analysis was conducted to quantify the number of red blood cells remaining in:
healthy liver tissue, after harvesting and rinsing with HTK®, IGL-1 and INV solutions; and
steatotic (“fatty”) liver tissue, after harvesting and rinsing with UW and INV solutions.

The results are shown in FIG. 5.

For a healthy liver, the data show that the liver rinsed with INV solution contains 7 times less red blood cells than the liver rinsed with the HTK® solution and 2 times less than the liver rinsed with the IGL-1® solution.

For a steatotic liver, the data show that the liver rinsed with INV solution contains more than 1.5 times less red blood cells than the liver rinsed with the UW® solution.

These results confirm that the solution according to this disclosure provides a better hepatic flushing than the solutions of the prior art.

5. Dynamic Perfusion of a Liver

5.1. Dynamic Perfusion in Hypothermic Liver Condition

A hypothermic perfusion machine is used to preserve a liver to be transplanted, this device allows to implement the HOPE (Hypothermic Oxygenated Perfusion) protocol which ensures passive oxygenation of the hypothermic perfusion, i.e., without oxygen transporter, which protects mitochondrial integrity, and allows to reduce ischemia-reperfusion lesions in the liver.

The liver to be transplanted is stored in a preservation solution for 7 hours, then placed in a hypothermic perfusion machine for 1 hour to be subjected to the HOPE protocol. The liver is then reperfused with a Krebs solution in normothermia.

The Perf-Gen® solution is one of the prior art solutions used in a hypothermic perfusion machine. This solution includes hydroxyethyl starch as an oncotic agent and glucose as an osmotic agent.

The purpose of these experiments is to compare the performance of the solution according to the disclosure (INV Solution) against the Perf-Gen® solution.

Different parameters were measured to evaluate the efficacy of the solution according to this disclosure on liver preservation under dynamic perfusion conditions in hypothermia:

5.2. Assessment of ALDH2 Content in Liver Tissue

The ALDH2 concentration was measured in healthy liver tissue to assess the protective properties to the cells of the organ to be transplanted of the INV solution used in a perfusion device according to the HOPE protocol (see point 3.4), compared to the Perf-Gen® solution.

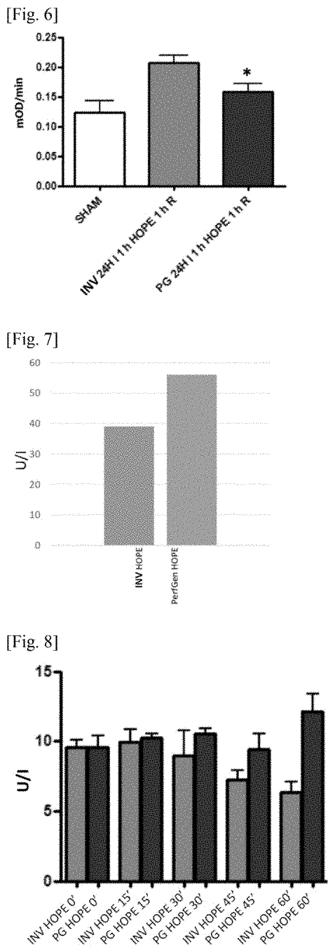

The results are shown in FIG. 6.

The data show that the INV solution according to this disclosure induces a significantly higher ALDH2 activity compared to the Perf-Gen® solution after a dynamic perfusion in hypothermia.

5.3. Assessment of Hepatic Parenchyma Degradation

5.3.1. Aspartate Aminotransferase

The content in aspartate aminotransferase (ASAT), a particular type of transaminase, was measured by enzyme kit 1 hour after being placed under HOPE protocol (see point 3.4).

The results are shown in FIG. 7.

The data show a lower ASAT content in hepatic tissue perfused with the solution according to this disclosure compared to the use of the prior art solution.

5.3.2. GLDH

The GLDH content was measured by enzyme kit, at the launch of the HOPE protocol and then every 15 minutes, at 0, 15, 30, 45 and 60 minutes.

The results are shown in FIG. 8.

The data show that perfusion with the INV solution ensures a decrease in GLDH content compared to the Perf-Gen® solution.

In conclusion, perfusion with the solution according to this disclosure of a liver in a hypothermic perfusion machine leads to lower levels of ASAT and GLDH, reflecting a decrease in the degradation of liver tissue compared to the Perf-Gen® solution.

6. Static Preservation of a Heart Under Hypothermia Condition

To assess the effectiveness of the preservation solution according to this disclosure, evaluations were carried out on “marginal” hearts meaning DCD (death by cardiocirculatory death)).

6.1. Experimental Conditions

The hearts of normal (healthy) pigs were collected and stored according to techniques known to the skilled person.

The purpose of these experiments is to compare the performance of the solution according to this disclosure (INV Solution) on the preservation of the heart in hypothermia ex vivo compared to Celsior® solution.

The organ is stored statically in the preserving solution (Celsior® or INV) for 4 hours at 4° C.

6.2 Assessment of Cell Degradation

The content in aspartate aminotransferase (ASAT), a particular type of transaminase, was measured by enzyme kit.

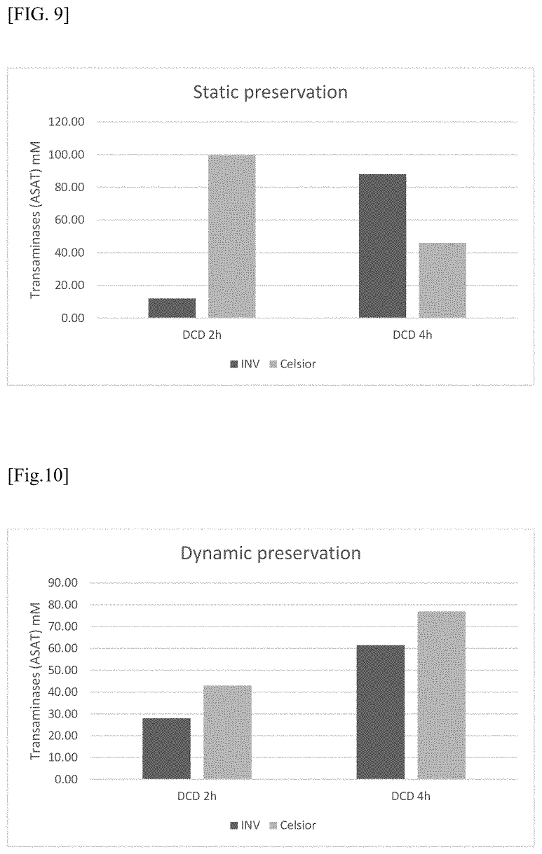

The results are shown in FIG. 9.

The data show an acceptable ASAT content in heart tissue preserved with the solution according to this disclosure compared to the use of the Celsior® even if Celsior® gives some better results in prolonged preservation conditions.

7. Dynamic Perfusion of a Heart

7.1. Dynamic Perfusion in Hypothermic Heart Condition

A hypothermic perfusion machine is used to preserve a heart to be transplanted, this device allows to implement the HOPE (Hypothermic Oxygenated Perfusion) protocol which ensures passive oxygenation of the hypothermic perfusion, i.e., without oxygen transporter, which protects mitochondrial integrity, and allows to reduce ischemia-reperfusion lesions in the heart.

The heart to be transplanted is placed in a hypothermic perfusion machine for 4 hours to be subjected to the HOPE protocol at 4° C. The pressure is maintained at a rate between 20-40 mm Hg and the flow rate is between 50-100 mL/min.

The Celsior® is one of the prior art solutions used in a hypothermic perfusion machine.

The purpose of these experiments is to compare the performance of the solution according to the disclosure (INV Solution) against Celsior® solution.

7.2 Assessment of Cell Degradation

The content in aspartate aminotransferase (ASAT), a particular type of transaminase, was measured by enzyme kit.

The results are shown in FIG. 10.

The data show a lower ASAT content in heart tissue perfused with the solution according to this disclosure compared to the use of Celsior®. In other words, the INV solution provides better preservation than the Celsior® solution when used in a hypothermic perfusion machine.

8. Conclusion

The solution according to this disclosure is suitable for use for static preservation in hypothermia of an organ to be transplanted and/or for dynamic preservation of the organ in a hypothermic perfusion device. In addition, in these 2 contexts of use, the INV solution according to this disclosure is more effective than the solutions of the prior art. INV allows protecting the organ to be transplanted and reducing damage to liver tissue caused by ischemia and reperfusion

1. A method comprising:
exposing an organ to be transplanted to an aqueous solution comprising:
sodium (Na⁺) ions at a concentration between 30 and 150 mmol·L⁻¹;
potassium ions (K⁺) at a concentration between 10 and 40 mmol·L⁻¹;
polyethylene glycol with a molecular weight of 35,000 g·mol⁻¹ (PEG 35000) at a concentration between 2 and 5 g·L⁻¹,
wherein the step of exposing further comprises preserving and/or rinsing and/or reconditioning the organ in the aqueous solution.

2. The method of claim 1, wherein the step of preserving is static.

3. The method of claim 2, wherein the temperature of the aqueous solution is between +1 and +12° C.

4. The method of claim 1, wherein the step of preserving is dynamic

5. The method of claim 4, wherein the temperature of the aqueous solution is between +1 and +12° C.

6. The method of claim 4, wherein the dynamic perfusion comprises the step of perfusing the organ continuously.

7. The method of claim 4, wherein the dynamic perfusion comprises the step of perfusing the organ with a pulsatile flow.

8. The method of claim 1, wherein the rinsing step comprises the aqueous solution having a temperature between +1 and +12° C.

9. The method of claim 1, wherein the conditioning step involves comprises the aqueous solution having a temperature between +1 and +12° C.

10. The method of claim 1, wherein the organ to be transplanted is an abdominal organ comprising one or more the liver, pancreas, kidney or intestines.

11. The method of claim 1, wherein the organ to be transplanted is the heart.

12. The method of claim 1, wherein the aqueous solution further comprises glutathione, as an antioxidant agent, at a concentration between 1 and 11 mmol·L⁻¹.

13. The method of claim 1, wherein the aqueous solution further comprises zinc ions (Zn²⁺) at a concentration between 0.08 and 0.210 mmol·L⁻¹.

14. The method of claim 1, wherein the aqueous solution further comprises nitrite ions (NO²⁻) at a concentration between 5 and 100 nmol·L⁻¹.

15. The method of claim 1, wherein the aqueous solution exhibits pH between 7.2 and 7.6.

16. The method of claim 1, wherein the aqueous solution further comprises an impermeable anion, a sugar, a cell membrane stabilizer, a buffer solution and/or an energy source.

17. The method of claim 1, wherein the aqueous solution further comprises:
raffinose at a concentration between 25 and 35 mmol·L⁻¹ and allopurinol at a concentration between 0.5 and 1.5 mmol·L⁻¹; or
mannitol at a concentration between 40 and 80 mmol·L⁻¹, or advantageously mannitol at a concentration between 40 and 80 mmol·L⁻¹ and histidine at a concentration between 25 and 35 mmol·L⁻¹.

18. The method of claim 1, wherein the aqueous solution further comprises:
lactobionic acid at a concentration between 80 and 120 mmol·L⁻¹;
sulphate ions (SO₄²⁻) at a concentration between 4 and 6 mmol·L⁻¹;
phosphate ions (PO₄³⁻) at a concentration between 20 and 30 mmol·L⁻¹; and
adenosine at a concentration between 4 and 6 mmol·L⁻¹.

19. The method of claim 1, wherein the aqueous solution comprises:
PEG 35000 at a concentration of 5 g·L⁻¹;
glutathione at a concentration of 9 mmol·L⁻¹;
Zn²⁺ ions at a concentration of 0.191 mmol·L⁻¹;
NO²⁻ ions at a concentration of 50 nmol·L⁻¹;
raffinose at a concentration of 30 mmol·L⁻¹;
lactobionic acid at a concentration of 100 mmol·L⁻¹;
SO₄²⁻ ions at a concentration of 5 mmol·L⁻¹;
PO₄³⁻ ions at a concentration of 25 mmol·L⁻¹;
adenosine at a concentration of 5 mmol·L⁻¹; and
allopurinol at a concentration of 1 mmol·L⁻¹.

20. The method of claim 1, wherein the aqueous solution comprises:
PEG 35000 at a concentration of 5 g·L⁻¹;
glutathione at a concentration of 9 mmol·L⁻¹;
Zn²⁺ ions at a concentration of 0.191 mmol·L⁻¹;
NO²⁻ ions at a concentration of 50 nmol·L⁻¹;
mannitol at a concentration of 60 mmol·L⁻¹;
lactobionic acid at a concentration of 100 mmol·L⁻¹;
SO₄²⁻ ions at a concentration of 5 mmol·L⁻¹;
PO₄³⁻ ions at a concentration of 25 mmol·L⁻¹; and
adenosine at a concentration of 5 mmol·L⁻¹.

21. The method of claim 1, wherein the aqueous solution comprises:
PEG 35000 at a concentration of 5 g·L⁻¹;
glutathione at a concentration of 9 mmol·L⁻¹;
Zn²⁺ ions at a concentration of 0.191 mmol·L⁻¹;
NO²⁻ ions at a concentration of 50 nmol·L⁻¹;
mannitol at a concentration of 60 mmol·L⁻¹;
histidine at a concentration of 30 mmol·L-1;
lactobionic acid at a concentration of 100 mmol·L⁻¹;
SO₄²⁻ ions at a concentration of 5 mmol·L⁻¹;
PO₄³⁻ ions at a concentration of 25 mmol·L⁻¹; and
adenosine at a concentration of 5 mmol·L⁻¹.
